(19) United States
(12) Patent Application Publication
(10) Pub. No.: US 2007/0157583 A1
(43) Pub. Date: Jul. 12, 2007

(54) Method for finishing an equestrian saddle and saddle made thereby

(76) Inventors: Jody Jetton, Campbell, TX (US); Donald Motsenbocker, McKinney, TX (US)

Correspondence Address: CASH KLEMCHUK POWERS TAYLOR LLP, CAMPBELL CENTRE II, 8150 NORTH CENTRAL EXPRESSWAY, SUITE 1575, DALLAS, TX, 75206, US

(21) Appl. No.: 11/327,769

(22) Filed: Jan. 6, 2006

(51) Int. Cl. B68G 1/00

(52) U.S. Cl. 54/44.7

(57) ABSTRACT

A method for finishing a leather horse saddle is provided. Metallic flakes with a desired color effect property are selected. The selected metallic flakes are combined with a sealer to form a sealant mixture. A portion of the sealant mixture is applied to at least a portion of the leather horse saddle. In an alternate embodiment, a first coat of the sealer is applied to at least a portion of the leather horse saddle. In an alternate embodiment, at least a portion of a surface of the leather horse saddle is colored. In an alternate embodiment, a selected oil is applied to at least a portion of the leather horse saddle. In an alternate embodiment, a hand tool is applied to the saddle leather to form decorative marks on at least a portion of the leather horse saddle.

### BACKGROUND

1. Field of the Invention

The present invention relates generally to equestrian equipment and in particular to a method for finishing an equestrian saddle and a saddle made thereby.

2. Description of Related Art

Modern equestrian saddles, particularly saddles employed in competitive or show riding, are typically manufactured from leather and are often decorated to improve their appearance. Streamers, hand-tooled marks, and other accoutrements are often applied to the saddle leather for decorative effect. Additionally, the saddle leather itself is often dyed or painted to produce color effects.

For many products, certain color effects are particularly attractive or desirable, such as, for example, “metallic” effects that, generally, mimic certain visual features of metallic objects. For example, a color effect often employed in automotive finishes is a “sparkle” effect wherein the treated automobile body appears to sparkle as if constructed out of a metallic crystalline base. Another common color effect employed on metal surfaces is a “liquid metal” effect wherein the treated surface appears as if constructed out of molten metal.

As typical equestrian saddles are constructed out of leather, however, attempts to reproduce attractive metallic-type color effects have met with limited success. Application of metallic paints typically employed to generate these color effects directly to saddle leather, as opposed to a metal surface for which the metallic paints are typically designed, often results in an unattractive finish, failing to exhibit the desired metallic-type color effect.

Direct application of metallic paints to leather also introduces problems. Metallic paints applied to saddle leather in particular are prone to difficulties with the paint adhering to and/or bonding with the saddle leather. Flaking and damage to the saddle leather with metallic paints, for example, can be particularly destructive to the saddle, and noticeable to the eye, as opposed to flat or standard leather paints.

Additionally, newly manufactured modern equestrian saddles typically require a lacquer or other sealant finish before regular use, to preserve and protect the leather. The sealants can be configured with certain visual characteristics, such as glossiness and transparency, but are not typically suitable for providing metallic-type color effects.

Moreover, sealant applied over metallic paint typically reduces what minimal metallic-type color effects the metallic paint can provide. The sealant itself can also mask or diminish the attractiveness of the underlying metallic paint, minimizing any benefits provided by the metallic paint. Also, depending on the interaction of the sealant with the metallic paint, the sealant can exacerbate flaking and other problems associated with applying metallic paint directly to the saddle leather.

A need exists, therefore, for a method for finishing an equestrian saddle and a saddle made thereby that overcomes problems and disadvantages associated with prior systems and methods.

Additionally, all references cited herein are incorporated by reference to the maximum extent allowable by law. To the extent a reference may not be fully incorporated herein, it is incorporated by reference for background purposes and indicative of the knowledge of one of ordinary skill in the art.

### SUMMARY

The problems presented in prior methods and systems are solved by the systems and methods of the present invention. In accordance with one embodiment of the present invention, a method for finishing a leather horse saddle is provided. Metallic flakes with a desired color effect property are selected. The selected metallic flakes are combined with a sealer to form a sealant mixture. A portion of the sealant mixture is applied to at least a portion of the leather horse saddle. A saddle manufactured in accordance with the method is also provided. In an alternate embodiment, a first coat of the sealer is applied to at least a portion of a surface of the leather horse saddle. In an alternate embodiment, at least a portion of a surface of the leather horse saddle is colored. In an alternate embodiment, a selected oil is applied to at least a portion of the leather horse saddle. In an alternate embodiment, a hand tool is applied to the saddle leather to form decorative marks on at least a portion of the leather horse saddle.

Other objects, features, and advantages of the present invention will become apparent with reference to the drawings and detailed description that follow.

### BRIEF DESCRIPTION OF THE DRAWINGS

FIG. 1 is flow diagram illustrating a method for finishing a leather saddle in accordance with one embodiment of the present invention.

FIG. 2 is a block diagram depicting a leather equestrian saddle in accordance with one embodiment of the present invention.

### DETAILED DESCRIPTION

All references cited herein are incorporated by reference to the maximum extent allowable by law. To the extent a reference may not be fully incorporated herein, it is incorporated by reference for background purposes and indicative of the knowledge of one of ordinary skill in the art.

In the following detailed description of the preferred embodiments, reference is made to the accompanying drawings, which form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the present invention is defined only by the appended claims.

Generally, as described above, preparing an equestrian saddle for its first operational use, or “finishing” the saddle, includes various steps designed to heighten the attractiveness of the saddle's appearance, without degrading its functionality. The method of the present invention is described herein with respect to certain novel steps to finish an equestrian saddle, or other suitable leather product. Accordingly, certain commons steps are omitted in order to avoid obscuring the present invention in unnecessary detail. One skilled in the art will understand that such common finishing steps can be incorporated into the below-described method where appropriate, without departing from the scope or spirit of the present invention.

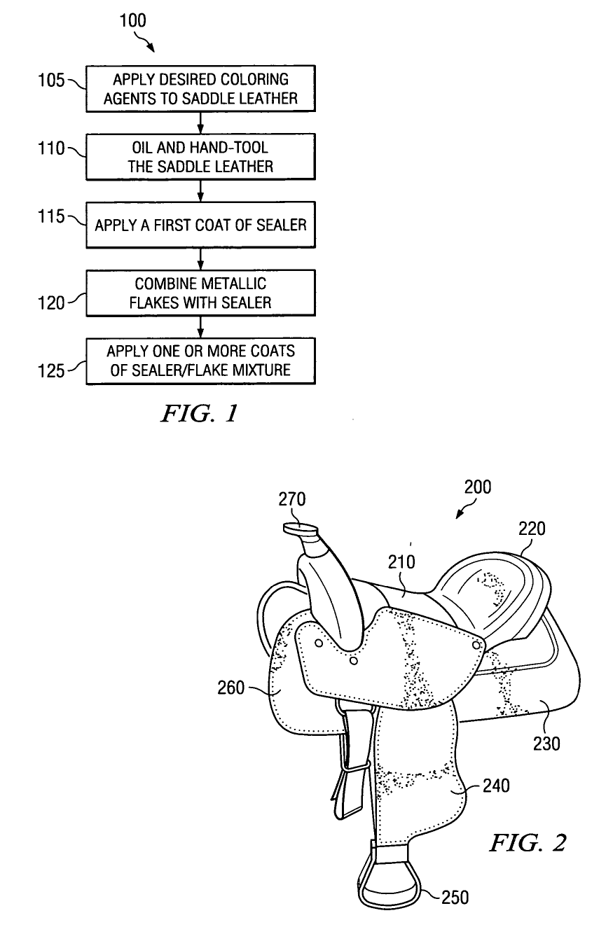

Referring now to FIG. 1, the reference numeral 100 generally designates a flow diagram illustrating a method for finishing a leather equestrian saddle in accordance with one embodiment of the present invention. The process begins at step 105, wherein the leather is colored. At step 105, some or all of the saddle leather is dyed or otherwise colored using conventional techniques to suit the desires of the saddle's end-user.

One skilled in the art will understand that step 105 can include applying conventional saddle-leather dye in a variety of patterns. Moreover, step 105 can also include applying one or more non-metallic paints or other suitable coloring substances to the saddle leather and/or saddle accessories. For example, the saddle leather can be dyed with multiple colors, in one or more patterns, covering some or all of the saddle.

Additionally, the particular dye or other coloring agents used can be selected based on their effect on the performance and longevity of the saddle leather to which the dyes are applied, as one skilled in the art will understand. Furthermore, one skilled in the art will understand that this step can include allowing the coloring to dry and/or cure.

At next step 110, some or all of the leather is oiled and/or hand-tooled. This step can include oiling the leather with protective oils and/or in preparation for hand-tooling. One skilled in the art will understand that certain oils applied to the leather make the leather more supple and easier to hand-tool.

Generally, hand-tooling the leather includes applying metal or wooden tools to the leather to produce decorative marks in the leather. One skilled in the art will understand that the decorative marks can include recessed patterns in the leather, shading effects created by graduated cut-outs in the leather, and other conventional and/or artistic marks.

This step can also include oiling the leather after hand-tooling to protect the leather and repair minor flaws caused by the hand-tooling process. In one embodiment, the leather is oiled with protective oils selected to help protect the leather against potentially damaging effects of the remaining finishing steps. Furthermore, this step can also include a curing period. One skilled in the art will understand that other configurations can also be employed.

At next step 115, a first coat of sealer is applied to some or all of the saddle leather. The applied sealer can be any of a number of conventional sealers, including specialty lacquers configured for one or more special effects. One skilled in the art will understand that the particular sealer selected can be configured for a saddle primarily used in a particular kind of light.

For example, the sealer can be selected based on its appearance, when cured, under sunlight, indoor electric light, a combination of light sources, or other suitable bases. In a preferred embodiment, the sealer is Resolene Brand sealer. Additionally, the sealer can be selected based on its ability to incorporate metallic flakes, as described with respect to step 120 below. One skilled in the art will understand that this step can also include a drying and/or curing period.

At next step 120, metallic flakes are mixed with the sealer. In a preferred embodiment, the metallic flakes are mixed with the sealer in a dedicated mixing container. That is, it is preferred that the first coat of sealer be applied from a container free of metallic flakes, and therefore preferred that subsequent coats that contain metallic flakes are prepared in a dedicated container.

In one embodiment, the metallic flakes can be small, flat plates of metal or other suitable substance. The flat plates can be manufactured from aluminum, mica, and/or other suitable substances. In one embodiment, each flat plate can be configured in a particular shape, such as, for example, a square, a circle, a five-pointed star, irregularly shaped, or other suitable shapes. In one embodiment, the metallic flakes mixed with the sealer comprise flat metal plates in a variety of shapes.

The flat plates can be configured in a variety of colors. One skilled in the art will understand that the palette of available colors can depend on the particular substance from which the flat plates are made. Furthermore, from the palette of available colors, the particular color employed can be selected based on the desires of the end-user and the color effect intended.

In another embodiment, the metallic flakes can be small, flat flakes of metallic paint. The metallic paint flakes can be manufactured from a variety of metallic paint bases. Moreover, the metallic paint flakes can be manufactured in a variety of manners. For example, in one embodiment, metallic paint is applied to a flat non-adhesive surface and allowed to dry. The dried metallic paint is scoured off of the non-adhesive surface in flakes suitable for mixing with the sealer. One skilled in the art will understand that other configurations can also be employed.

In one embodiment, the metallic paint flakes are House of Kolor Brand paint flakes and are mixed with Resolene Brand sealer. In an alternate embodiment, the metallic paint flakes are pearl paint powder and are mixed with Resolene Brand sealer. In a particular embodiment, the pearl paint powder is PPG Brand paint powder. One skilled in the art will understand that other suitable metallic paint flakes can also be employed.

The metallic paint flakes can also be configured in a variety of colors. One skilled in the art will understand that the palette of available colors can depend on the metallic paint from which the metallic paint flakes are made. Furthermore, from the palette of available colors, the particular color employed can be selected based on the desires of the end-user and the color effect intended. In one embodiment, the particular color employed is selected to approximately match a seat color of the saddle to which the mixture is applied. In an alternate embodiment, the particular color employed is selected based on a seat color of the saddle to which the mixture is applied. Additionally, the particular color employed in step 120 can be based in part on the particular color or colors employed in step 105. One skilled in the art will understand that other criteria and/or configurations can also be employed.

In a preferred embodiment, the sealer is typically aqueous and configured to suspend the metallic flakes rather than absorb or dissolve the metallic flakes. Furthermore, the density of the aqueous sealer is such that the metallic flakes can be evenly distributed throughout the solution. That is, the sealer is not so dense that the metallic flakes all float to the surface of the solution, nor is the sealer so fluid that the metallic flakes all sink to the bottom of the solution. As described above, in a preferred embodiment, the sealer is Resolene Brand sealer. One skilled in the art will understand that other suitable sealers can also be employed.

Additionally, in a preferred embodiment, the metallic flakes are mixed with the sealer in a particular proportion. One skilled in the art will understand that too high a proportion of metallic flakes can render the sealer unable to cure properly or be ineffective as a sealant. Similarly, too few metallic flakes will not provide an observable color effect or will not provide the desired color effect. Accordingly, in a preferred embodiment, the metallic flakes are mixed with the sealer in a ratio of 2 tablespoons of flakes to 1 quart of sealer. In an alternate embodiment, 1 tablespoon of paint is mixed with 1 quart of sealer. One skilled in the art will understand that other configurations and/or combinations can also be employed.

At next step 125, one or more additional coats of the sealer and metallic flake mixture are applied to some or all of the saddle leather. One skilled in the art will understand that this step can include a drying and/or curing period between coats. Furthermore, this step can include applying a varying number of coats of the sealer and metallic flake mixture to various parts of the saddle leather.

For example, the parts of the saddle typically obscured from view by the rider, or more subject to friction wear by the action of riding, can require fewer or no coats of the sealer/flake mixture. Instead, one or more coats of a different sealer altogether can be applied in such areas, with the sealer/flake mixture applied in one or more coats only to those areas of the saddle subject to view by judges and/or spectators. One skilled in the art will understand that other configurations can also be employed.

Furthermore, one skilled in the art will understand that the steps as described above comprise an optional, preferred embodiment of the present invention. In an alternate embodiment, one or more steps can be omitted or performed out of the order described above. For example, in one embodiment, steps 105, 110, and 115 can be omitted. Additionally, as described above, one or more of the steps can be selectively applied to some portions of the saddle and omitted as to other portions of the saddle.

For example, referring now to FIG. 2, the reference numeral 200 generally designates an equestrian saddle in accordance with one embodiment of the present invention. Saddle 200 includes a seat 210, a cantle 220, a skirt 230, a fender 240, a stirrup 250, a lining 260, and a horn 270. One skilled in the art will understand that the illustrated components of saddle 200 can be configured in a wide variety of combinations and that certain components can be omitted altogether. For example, many equestrian saddles are configured without a horn 270. The particular components shown are selected for ease of illustration and are not to be construed as limiting in any way.

In the illustrated embodiment, the sealer/flake mixture is selectively applied to a subset of the components of saddle 200. In particular, the sealer/flake mixture is applied to cantle 220 and skirt 230, and is not applied to seat 210, fender 240, stirrup 250, lining 260, or horn 270. In an alternate embodiment, the sealer/flake mixture can be applied to a jockey (not shown), rear housing (not shown), swell (not shown), and/or saddle flap (not shown). In a preferred embodiment, the sealer/flake mixture is not applied to the seat 210, fender 240, stirrup leather (not shown), stirrup 250, or sweat flap (not shown). One skilled in the art will understand that other configurations can also be employed.

Thus, the primary advantage of the present invention is providing a method for finishing a saddle that allows for improved decorative effects and, in particular, improved color effects. Another advantage of the present invention is providing a method for finishing a saddle with a decorative color effect that is consistent with modern leather saddle preservation and protection methods. Still another advantage of the present invention is providing a method for finishing a saddle with a decorative color effect that does not cause excessive damage to the underlying saddle leather. One skilled in the art will appreciate other advantages of the present invention.

Even though many of the examples discussed herein are applications of the present invention in the field of leather equestrian saddles, the present invention also can be applied to other types of leather products, particularly products designed for live entertainment, including but not limited to leather garments for stage shows, leather fixtures and features of props and/or set pieces for live performances, and other suitable fields where it is desired that a leather product be attractive and durable. Therefore, one skilled in the art will see that the present invention can be applied in many areas where there is a need to provide metallic color effects on leather goods, particularly equestrian saddles, that is consistent with the preservation and protection of the goods.

It should be apparent from the foregoing that an invention having significant advantages has been provided. While the invention is shown in only a few of its forms, it is not just limited but is susceptible to various changes and modifications without departing from the spirit thereof.

We claim:

1. A method for finishing a leather horse saddle, comprising:
selecting metallic flakes with a desired color effect property;
combining the selected metallic flakes with a sealer to form a sealant mixture; and
applying a portion of the sealant mixture to at least a portion of the leather horse saddle.

2. The method according to claim 1, further comprising:
applying a first coat of the sealer to at least a portion of the leather horse saddle.

3. The method according to claim 1 further comprising:
coloring at least a portion of a surface of the leather horse saddle;
applying a selected oil to at least a portion of the leather horse saddle; and applying a hand tool to the saddle leather to form decorative marks on at least a portion of the leather horse saddle.

4. The method according to claim 1 further comprising applying a selected oil to at least a portion of the leather horse saddle.

5. The method according to claim 1 further comprising applying a hand tool to the saddle leather to form decorative marks on at least a portion of the leather horse saddle.

6. The method according to claim 1 further comprising coloring at least a portion of a surface of the leather horse saddle.

7. The method according to claim 1 wherein the metallic flakes are flat square plates.

8. The method according to claim 1 wherein the metallic flakes are flat circular plates.

9. The method according to claim 1 wherein the metallic flakes are flat irregularly shaped plates.

10. The method according to claim 1 wherein the metallic flakes are flat five-pointed star-shaped plates.

11. The method according to claim 1 wherein the sealer comprises Resolene Brand sealer.

12. The method according to claim 1 wherein the metallic flakes comprise metallic paint flakes.

13. The method according to claim 1 wherein the metallic flakes comprise House of Kolor Brand metallic paint flakes.

14. An equestrian saddle manufactured through the method according to claim 1.

15. A method for finishing a leather horse saddle, comprising:
combining metallic flakes with a sealer to form a sealant mixture; and
applying a portion of the sealant mixture to a portion of the leather horse saddle.

16. An equestrian saddle manufactured through the method according to claim 15.
